(19) United States
(12) Patent Application Publication
(10) Pub. No.: US 2026/0197592 A1
(43) Pub. Date: Jul. 9, 2026

(54) HEARING AID COMBINED WITH AUGMENTED REALITY GLASSES

(71) Applicant: International Business Machines Corporation, Armonk, NY (US)

(72) Inventors: Paul Turner, Leander, TX (US); Brad Hoover, Austin, TX (US); Tam Chinh Tran, Austin, TX (US); Emily Megan Metruck, Poughkeepsie, NY (US); William Lyle Goleman, Nashua, NH (US)

(21) Appl. No.: 19/009,520

(22) Filed: Jan. 3, 2025

(51) Int. Cl. H04R 25/00; G06F 3/01; G10L 15/00; H04S 7/00

(52) U.S. Cl. CPC H04R 25/505; G06F 3/013; G10L 15/005; H04S 7/301; H04R 2225/43; H04S 2400/11

(57) ABSTRACT

A system includes a processor that executes computer executable components stored in memory. The computer executable components can comprise an identification component that identifies a point of interest of a wearer of an augmented reality headset, wherein the augmented reality headset includes microphones and audio transmitter. The computer executable components can further comprise a focus component that isolates audio data received associated with the point of interest. The computer executable components can further comprise an output component that amplifies isolated audio data output by the audio transmitter.

### TECHNICAL FIELD

The subject disclosure relates to the isolation of target speech, e.g., utilizing augmented reality glasses paired with a hearing aid device to facilitate clear communication in loud environments.

### BACKGROUND

Hearing aids, while effective in amplifying sound, often struggle to differentiate between background noise and voices of people nearby. In loud or crowded environments, hearing speech accurately or clearly is a significant challenge for those relying on hearing aids. Often, users can struggle to pick out individual voices, making conversations difficult.

Limitations of current hearing aid technology are further evident in industrial contexts, where loud machinery noise is common, and clear communication is crucial for safety and efficiency. In such settings, noise-canceling headphones are frequently used to protect hearing, but do not address the issue of distinguishing speech.

Currently, to focus hearing on an intended individual in a loud or crowded environment, users employ a combination of hand-held parabolic microphones and noise-canceling headphones. The process involves manually directing a parabolic microphone toward a desired speaker and adjusting volume to isolate his/her voice. This method can be cumbersome and impractical for everyday use.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate clear communication in loud environments.

According to an embodiment, a system can comprise a processor that executes computer executable components stored in memory. The computer executable components can comprise an identification component that identifies a point of interest of a wearer of an augmented reality headset, wherein the augmented reality headset includes microphones and audio transmitter. The computer executable components can further comprise a focus component that isolates audio data received associated with the point of interest. The computer executable components can further comprise an output component that amplifies isolated audio data output by the audio transmitter.

According to another embodiment, a computer-implemented method can comprise identifying, by a system operatively coupled to a processor, a point of interest of a wearer of an augmented reality headset, wherein the augmented reality headset includes microphones and audio transmitter. The computer-implemented method comprises isolating, by a system, audio data received associated with the point of interest. The computer-implemented method further comprises amplifying, by a system, the isolated audio data output by the audio transmitter.

According to another embodiment, a computer program product comprising a computer readable storage medium having program instructions embodied therewith, the program instructions executable by a processor to cause the processor to identify, by the processor, a point of interest of a wearer of an augmented reality headset, wherein the augmented reality headset includes microphones and audio transmitter. The program instructions can cause the processor to isolate, by the processor, audio data received associated with the point of interest. The program instructions can cause the processor to amplify, by the processor, the isolated audio data output by the audio transmitter.

### BRIEF DESCRIPTION OF THE DRAWINGS

FIGS. 1 and 2 illustrate example systems that can facilitate clear communication in loud environments in accordance with some embodiments described herein.

FIGS. 3 and 4 illustrate flow diagrams, for example computer implemented methods that can facilitate clear communication in loud environments in accordance with some embodiments described herein.

FIG. 5 illustrates an example process flow diagram of a selective audio system in accordance with some embodiments described herein.

FIG. 6 illustrates an example subprocess flow diagram of audio level monitoring in a selective audio system in accordance with some embodiments described herein.

FIG. 7 illustrates an example process flow diagram of a user actions when using the augmented reality glasses paired with a hearing aid device in accordance with some embodiments described herein.

FIG. 8 illustrates an example structure for augmented reality glasses with a hearing aid device in accordance with some of the embodiments described herein.

FIG. 9 illustrates an example interface for augmented reality glasses with a hearing aid device in accordance with some of the embodiments described herein.

FIG. 10 illustrates an example private communication mode to enable secure and discrete interactions between multiple users in accordance with some of the embodiments described herein.

FIG. 11 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Hearing aids are widely used by individuals with hearing impairments to amplify sounds and improve access to verbal communication. However, current hearing aid technology exhibits significant limitations in environments where background noise levels are high or auditory signals are complex. Traditional hearing aids amplify surrounding sounds indiscriminately. This can make it difficult for a user to focus on a specific auditory source, such as a nearby speaker, over background noise. In noisy or crowded settings, such as restaurants, social gatherings, or public spaces, users often find it challenging to separate relevant speech from surrounding noise. This can lead to difficulty in understanding conversations and can leave users struggling to engage in meaningful communication.

Limitations of communicating in loud environments are even more pronounced in industrial or commercial environments. In such environments, loud machinery, ventilation systems, or other continuous noise sources are common. In industrial or commercial settings, accurate communication, such as instructions or alerts, are critical for maintaining safety protocols and operational efficiency. To protect workers in loud environments, standard noise-canceling headphones are commonly used to reduce overall noise but lack capability to isolate or enhance individual voices. Thus, such devices fall short of providing a targeted hearing experience.

Other solutions, such as hand-held parabolic microphones coupled with noise-canceling headphones, are impractical for real-time or continuous use, as such devices require manual operation and constant adjustments of a microphone toward a desired speaker. Current options for hearing enhancement technology do not provide a seamless solution for allowing users to communicate in loud or crowded environments.

To address these challenges, combining augmented reality glasses with a hearing aid device can improve manner in which people interact in loud or crowded environments by facilitating focused listening. Augmented reality glasses can include a real-time user interface that allows a user to adjust audio quality to user preferences. Additionally, augmented reality glasses can track intended source of audio even if it moves out of view. A system can utilize audio processing technology to detect, prioritize, or clarify speech of a targeted audio source or speaker. Additionally, various methods can be used, such as data compression or decompression, automatic echo cancellation, resampling, filtering, equalization, automatic gain control (AGC), loudness control, or beamforming, to filter and adjust volume levels to a desired state. Augmented reality glasses can be coupled with a hearing aid device or can utilize audio transmitters built into the glasses to receive clear and focused audio.

Such technology could be utilized in industrial settings. In industrial environments, noise-canceling headphones are often used to block out noise of loud equipment. Innovations disclosed herein can improve interactions around heavy machinery, facilitate effective team communication, and contribute to a safer working environment by allowing users to better understand each other in high-noise settings.

Additionally, embodiment can be used in crowded or loud social environments such as restaurants or sporting events. In crowded restaurants, when there are a lot of people talking around a person wearing a hearing aid, it makes it difficult to pinpoint a single conversation. At sporting events, loud crowds or announcements can make it challenging to hear someone seated nearby. Pairing augmented reality glasses with a hearing aid device can enhance experience of attending events, especially for those that rely on hearing aids.

In relation to focused speech enhancement for loud environments, embodiments disclosed herein produce a solution to one or more of these problems. These embodiments can solve such problems by identifying a point of interest of a wearer of an augmented reality headset, wherein the augmented reality headset includes microphones and audio transmitter; by isolating audio data received associated with point of interest; amplifying isolated audio data output by an audio transmitter.

According to an embodiment, a system can include a processor that executes computer executable components stored in a memory. The computer executable components can include an identification component that identifies a point of interest of a wearer of an augmented reality headset, wherein the augmented reality headset includes microphones and audio transmitter. The computer executable components can further include a focus component that isolates audio data received associated with the point of interest. The computer executable components can further include an output component that amplifies isolated audio data output by the audio transmitter.

In some embodiments, the system can further comprise a language processing component that converts languages in real time to the wearer. In such an embodiment, the language processing component can allow users to understand and communicate across language barriers instantly. The ability for real-time cross language communication can facilitate seamless interactions in multicultural environments, such as workplaces, travel, or healthcare.

In various embodiments, the identification component can use eye movement tracking to identify the point of interest of the wearer. By utilizing eye movement tracking, the system can intuitively identify the audio source of interest of the user and can facilitate natural interactions in noisy environments. The identification component can further track movement of an audio source. If the audio source of interest moves out of view of the user, the system can still enhance the audio from the source of interest.

In some embodiments, the focus component can filter background noise. The focus component can enhance the audio experience in loud or crowded environments by filtering background noise, making the audio from the audio source of interest clearer.

In other embodiments, the output component can adjust settings in real time to improve audio quality. The system can automatically tune the audio settings to improve based on the environment. For example, if the user is in a crowded and loud environment, the system can increase the volume of the audio from the audio source of interest. According to an embodiment, the output component can be configured to adjust sound settings to optimize hearing for a selected sound source. Additionally, the user can manually tune their audio settings to improve their user experience. In some embodiments, the user can specify audio level settings, such as minimum or maximum audio level thresholds.

In some embodiments, the system can further comprise a storage component that can save stored volume thresholds for the audio source and background noise. Users can save their preferences so that manual configuration of audio settings is not needed.

In various embodiments, the system can further comprise an artificial intelligence component that trains an artificial intelligence model on wearer preferences. According to some embodiments, the artificial intelligence component can automatically adjust hearing settings based on the wearer preferences. In such an embodiment, the artificial intelligence component can ensure a personalized listening experience by automatically adjusting sound levels and filtering based on individual needs and habits, enhancing comfort and usability in various environments.

Advantages of this system may include improved communication efficiency, safety in loud environments, and ease of use across varied applications.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

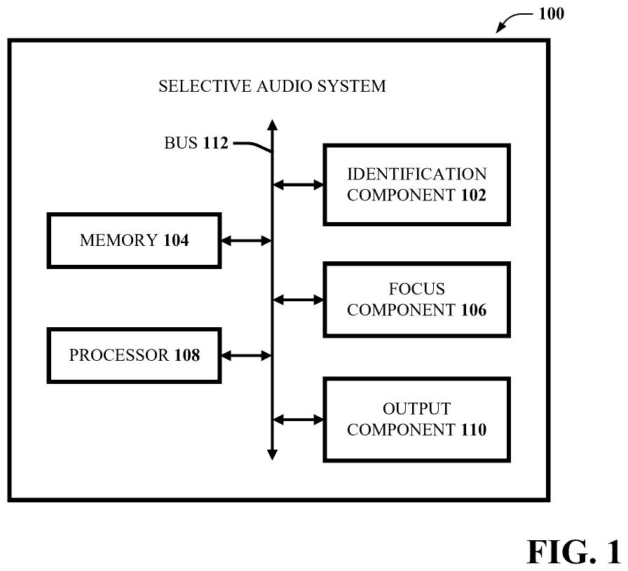

FIG. 1 illustrates an example system 100 for facilitating clear communication in loud environments. System 100 uses an identification component 102, a focus component 106, and an output component 110. The identification component 102 identifies a point of interest of a wearer of an augmented reality headset, wherein the augmented reality headset includes microphones and audio transmitter. The focus component 106 isolates audio data received associated with the point of interest. The output component 110 amplifies isolated audio data output by the audio transmitter.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise an identification component 102, a memory 104, a focus component 106, a processor 108, an output component 110, and a system bus 112.

The system 100 and/or components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to speech enhancement in loud environments.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the identification component 102, the focus component 106, and/or the output component 110) to perform one or more actions. In some embodiments, the memory 104 can store computer-executable components (e.g., the identification component 102, the focus component 106, and/or the output component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, identification component 102 identifies a point of interest of a wearer of an augmented reality headset, wherein an augmented reality headset includes microphones and audio transmitter. Identification component 102 can use eye movement tracking to identify point of interest of a wearer. In some embodiments, the system sets a predefined threshold in seconds during which it identifies an audio source of interest based on duration of a user's visual focus. By identifying an audio source of interest, the system can prioritize relevant audio or visual information, creating a more immersive experience in noisy environments. The identification component 102 can track movement of an audio source. If the audio source of interest moves out of view of the user, the system can still enhance audio from source of interest.

According to some embodiments, focus component 106 isolates audio data received associated with point of interest. Focus component 106 can filter background noise. The focus component 106 can enhance audio experience in loud or crowded environments by filtering background noise, making audio from the audio source of interest more clear.

In various embodiments, output component 110 can amplify isolated audio data output by an audio transmitter. Output component 110 can adjust settings in real time to improve audio quality. In some embodiments, the system can automatically tune audio settings to improve audio reception based on environment. The output component 110 can further adjust sound settings to optimize hearing for a selected sound source. In other embodiments, a user can manually tune audio settings to improve user experience. In some embodiments, the user can specify audio level settings, such as minimum or maximum audio level thresholds.

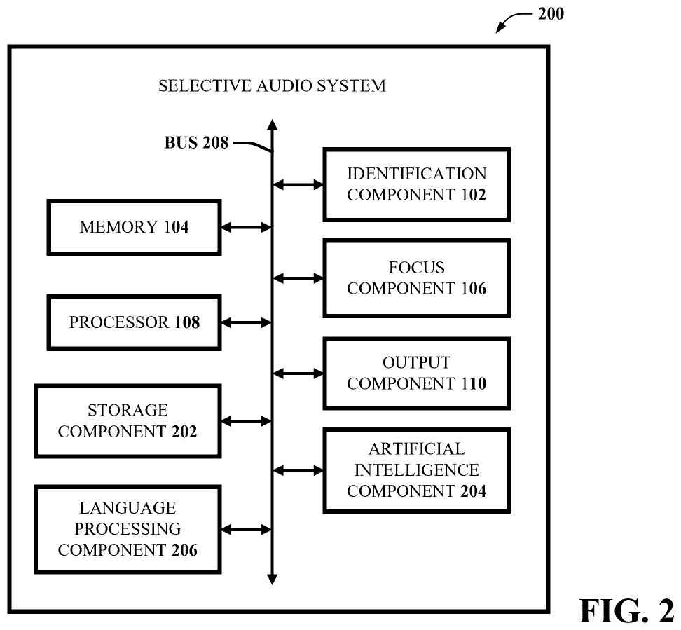

FIG. 2 illustrates an example system 200 that can facilitate clear communication in loud environments. System 200 uses identification component 102, focus component 106, output component 110, storage component 202, artificial intelligence component 204, and language processing component 206. Identification component 102 identifies a point of interest of a wearer of an augmented reality headset, wherein the augmented reality headset includes microphones and audio transmitter. Focus component 106 isolates audio data received associated with point of interest. The output component 110 amplifies isolated audio data output by an audio transmitter. Description of like components has been omitted for the sake of brevity.

In various embodiments, storage component 202 can save stored volume thresholds for an audio source and background noise. Users can save preferences so that manual configuration of audio settings is not needed.

According to some embodiments, artificial intelligence component 204 can train an artificial intelligence model on wearer preferences. In other embodiments, artificial intelligence component 204 can automatically adjust hearing settings based on the wearer preferences. In such an embodiment, the artificial intelligence component can ensure a personalized listening experience by automatically adjusting sound levels and filtering based on individual needs and habits, enhancing comfort and usability in various environments.

In various embodiments, language processing component 206 can convert languages in real time to a wearer. In such an embodiment, the language processing component can allow users to understand and communicate across language barriers instantly.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. Components can interact with one or more other components not specifically described herein for sake of brevity but known by those of skill in the art.

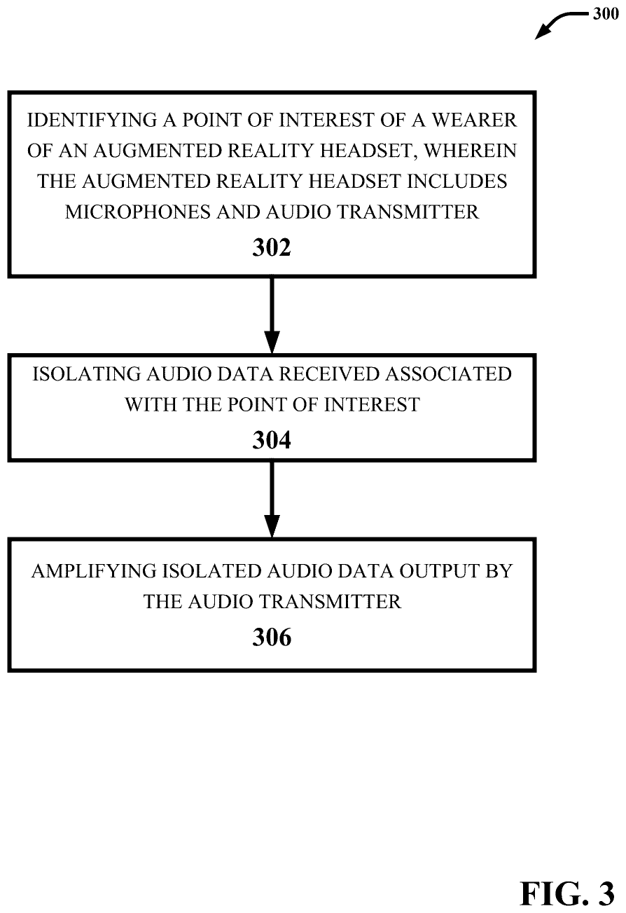

Next, FIG. 3 illustrates a flow diagram of a method 300 that can facilitate clear communication in loud environments in accordance with some embodiments described herein, such as the system 200 of FIG. 2 and the system 100 of FIG. 1. While method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, method 300 includes identifying a point of interest of a wearer of an augmented reality headset, wherein the augmented reality headset includes microphones and audio transmitter. Method 300 can use a system operatively coupled to the processor (e.g., identification component 102) to identify a point of interest of a wearer. The audio source of interest can be identified by eye movement tracking. In some embodiments, the system can identify the audio source of interest by determining if the user focuses on an audio source for a predefined number of seconds.

At 304, method 300 includes isolating audio data received associated with the point of interest. The method 300 can use a system operatively coupled to the processor (e.g., focus component 106) to isolate audio data received associated with the point of interest. In some embodiments, the system can modify the level of background noise cancellation and audio levels from the audio source of interest to enhance the listening experience.

At 306, the method 300 includes amplifying the isolated audio data output by the audio transmitter. The method 300 can use a system operatively coupled to the processor (e.g., output component 110) to amplify isolated audio data output by the audio transmitter.

In some embodiments, method 300 is performed by a system, such as system 100 of FIG. 1 or system 200 of FIG. 2. The includes identifying a point of interest of a wearer of an augmented reality headset, wherein the augmented reality headset includes microphones and audio transmitter 302 can be performed by an identification component (e.g., identification component 102 of FIG. 2). The isolating audio data received associated with the point of interest 304 can be performed by a focus component (e.g., focus component 106). Amplifying the isolated audio data output by the audio transmitter 306 can be performed by an output component (e.g., output component 110).

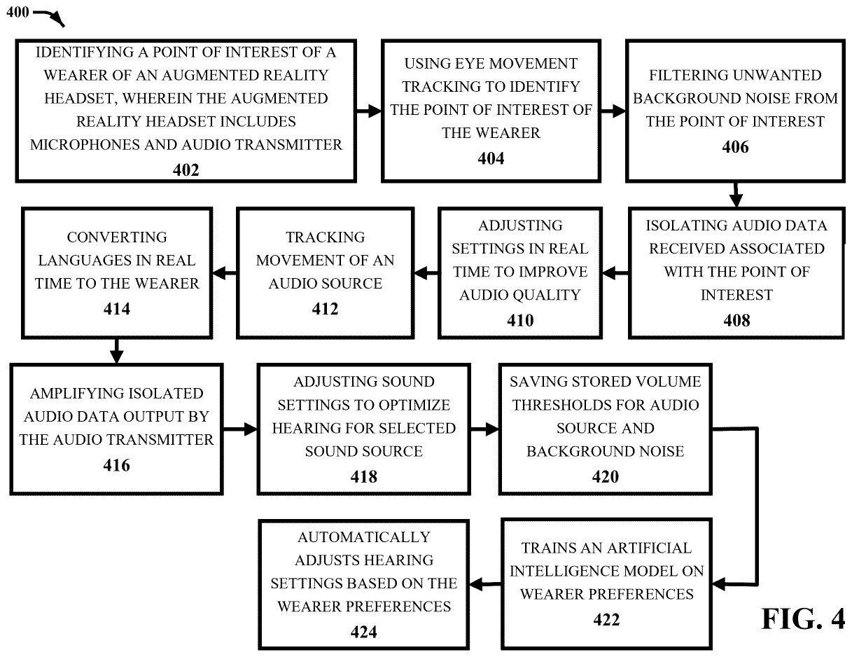

Next, FIG. 4 illustrates a flow diagram of a method 400 that can facilitate clear communication in loud environments in accordance with some embodiments described herein. While the method 400 is described relative to the system 200 of FIG. 2, the method 400 can be applicable also to other systems described herein, such as the system 100 of FIG. 1.

At 402, the method 400 includes identifying a point of interest of a wearer of an augmented reality headset, wherein the augmented reality headset includes microphones and audio transmitter. The method 400 can use a system operatively coupled to the processor (e.g., identification component 102) to identify a point of interest of a wearer.

At 404, the method 400 includes using eye movement tracking to identify the point of interest of the wearer. The method 400 can use a system operatively coupled to the processor (e.g., identification component 102) to use eye movement tracking to identify the point of interest of the wearer. In some embodiments, the system can identify the audio source of interest by determining if the user focuses on an audio source for a predefined number of seconds.

At 406, the method 400 includes filtering unwanted background noise from the point of interest. The method 400 can use a system operatively coupled to the processor (e.g., focus component 106) to filter unwanted background noise from the point of interest.

At 408, the method 400 includes isolating audio data received associated with the point of interest. The method 400 can use a system operatively coupled to the processor (e.g., focus component 106) to isolate audio data received associated with the point of interest.

At 410, the method 400 includes adjusting settings in real time to improve audio quality. The method 400 can use a system operatively coupled to the processor (e.g., focus component 106, output component 110) to adjust settings in real time to improve audio quality. In some embodiments, the system can modify the level of background noise cancellation and audio levels from the audio source of interest to enhance the listening experience. According to some embodiments, the system can use the user's saved audio preference levels to adjust the audio and background noise cancelation levels.

At 412, the method 400 includes tracking movement of an audio source. The method 400 can use a system operatively coupled to the processor (e.g., identification component 102, focus component 106) to track movement of an audio source. In some embodiments, the audio source can be tracked by the multiple microphones located on the augmented reality glasses.

At 414, the method 400 includes converting languages in real time to the wearer. The method 400 can use a system operatively coupled to the processor (e.g., language processing component 206) to convert languages in real time to the wearer.

At 416, the method 400 includes amplifying the isolated audio data output by the audio transmitter. The method 400 can use a system operatively coupled to the processor (e.g., output component 110) to amplify isolated audio data output by the audio transmitter.

At 418, the method 400 includes adjusting sound settings to optimize hearing for selected sound source. The method 400 can use a system operatively coupled to the processor (e.g., focus component 106, output component 110) to adjust sound settings to optimize hearing for selected sound source.

At 420, the method 400 includes saving stored volume thresholds for audio source and background noise. The method 400 can use a system operatively coupled to the processor (e.g., storage component 202) to save stored volume thresholds for audio source and background noise. In some embodiments where the user has not set thresholds for audio source volume and background noise levels, a default value can be used.

At 422, the method 400 includes training an artificial intelligence model on wearer preferences. The method 400 can use a system operatively coupled to the processor (e.g., artificial intelligence component 204) to train an artificial intelligence model on wearer preferences.

At 424, the method 400 includes automatically adjusting hearing settings based on the wearer preferences. The method 400 can use a system operatively coupled to the processor (e.g., artificial intelligence component 204) to automatically adjust hearing settings based on the wearer preferences.

One or more systems, devices, computer program products, and/or computer-implemented methods provided herein relate to facilitating clear communication in loud environments. A system can include a processor that executes computer executable components stored in memory. The computer executable components can include an identification component that identifies a point of interest of a wearer of an augmented reality headset, wherein the augmented reality headset includes microphones and audio transmitter. The computer executable components can further include a focus component that isolates audio data received associated with the point of interest. The computer executable components can further include an output component that amplifies isolated audio data output by the audio transmitter. In some embodiments, the computer executable components can include a storage component that saves stored volume thresholds for the audio source and background noise. In other embodiments, the computer executable components can include an artificial intelligence component that trains an artificial intelligence model on wearer preferences. In various embodiments, the computer executable components can include a language processing component that converts languages in real time to the wearer.

Advantages of this system may include improved communication efficiency, safety in loud environments, and ease of use across varied applications.

According to some embodiments, the identification component can identify a point of interest of a wearer of an augmented reality headset, wherein the augmented reality headset includes microphones and audio transmitter. In various embodiments, the identification component can use eye movement tracking to identify the point of interest of the wearer. By utilizing eye movement tracking, the system can intuitively identify the audio source of interest of the user and can facilitate natural interactions in noisy environments. The identification component can further track movement of an audio source. If the audio source of interest moves out of view of the user, the system can still enhance the audio from the source of interest.

The focus component can isolate audio data received associated with the point of interest. In some embodiments, the focus component can filter background noise. The focus component can enhance the audio experience within loud or crowed environments by decreasing the background noise. By filtering the background noise, the audio from the source of interest can become clearer to hear.

The output component can amplify isolated audio data output by the audio transmitter. In other embodiments, the output component can adjust settings in real time to improve audio quality. The system can automatically tune the audio settings to improve based on the environment. For example, if the user is in a crowded and loud environment, the system can increase the volume of the audio from the source of interest. According to an embodiment, the output component can be configured to adjust sound settings to optimize hearing for a selected sound source. Additionally, the user can manually tune their audio settings to improve their user experience.

In some embodiments, the system can further comprise a language processing component that converts languages in real time to the wearer. In such an embodiment, the language processing component can allow users to understand and communicate across language barriers instantly. The ability for real-time cross language communication can facilitate seamless interactions in multicultural environments, such as workplaces, travel, and healthcare.

In some embodiments, the system can further comprise a storage component that can save stored volume thresholds for the audio source and background noise. Users can save their preferences so that manual configuration of audio settings is not needed.

In various embodiments, the system can further comprise an artificial intelligence component that trains an artificial intelligence model on wearer preferences. According to some embodiments, the artificial intelligence component can automatically adjust hearing settings based on the wearer preferences. In such an embodiment, the artificial intelligence component can ensure a personalized listening experience by automatically adjusting sound levels and filtering based on individual needs and habits, enhancing comfort and usability in various environments.

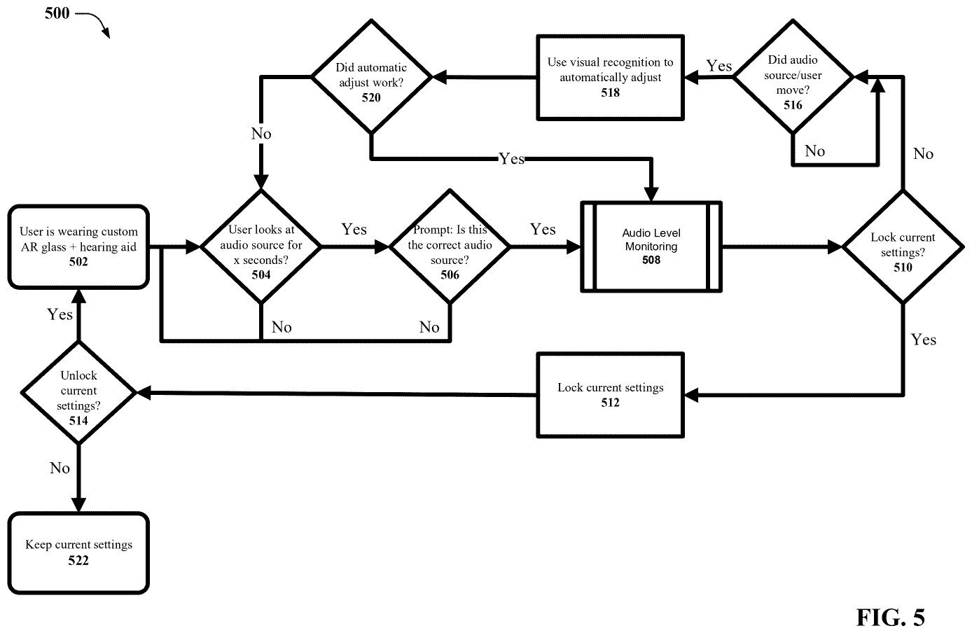

FIG. 5 illustrates an example process flow diagram of a selective audio system in accordance with some embodiments described herein.

At 502, a user can wear the augmented reality glass with a hearing aid device designed for interaction with the system.

At 504, the system can determine if the number of seconds that the user looks at a specific audio source meets a threshold to be identified as the potential audio source of interest. For general operation, the user focuses on an audio source for predefined number of seconds. The volume of the source can be measured by microphones built into the augmented reality glasses.

If the duration spent looking at the audio source meets the threshold for a potential audio source of interest, the system can prompt the user to confirm whether the identified audio source is indeed the intended source of interest 506. If the duration spent looking at the audio source is below the threshold for a potential audio source of interest, the system can go back to 504 to determine if the user looks at a specific audio source meets a threshold to be identified as the potential audio source of interest.

If the user confirms that the identified audio source is indeed the intended source of interest 506, the system can progress to the audio level monitoring subprocess 508. If the user confirms that the identified audio source is not the intended source of interest 506, the system can go back to 504 to determine if the user looks at a specific audio source meets a threshold to be identified as the potential audio source of interest. If the user has not set minimum or maximum thresholds for audio source volume, a default value can be used.

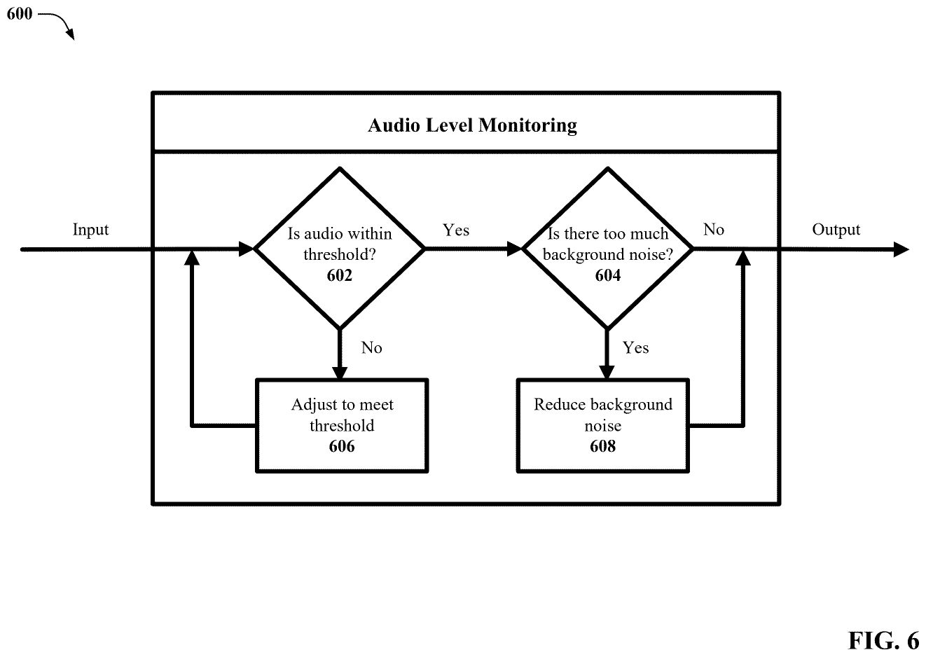

The audio level monitoring subprocess is described in FIG. 6. The audio level monitoring subprocess can adjust audio levels to desired thresholds. Additionally, the audio level monitoring subprocess can adjust the levels of background noise perceived by the user.

At 510, the system can determine whether to lock the current settings. If the system decides to lock the current settings, it can do so at step 512. If the system decides not to lock the current settings, the system can decide whether the audio source of interest or the user moved 516.

At 516, if the system determines that either the audio source of interest or the user has moved, it can use visual recognition to automatically adjust its focus or settings accordingly 518. If the system determines that neither the audio source of interest nor the user has moved, the system can go back to determine whether the current audio source of interest of the user has moved 516.

At 520, the system can determine if the automatically adjustment to the settings in 518 was successful. If the system determines that the adjustment of the setting was successful, the system can proceed back to the audio level monitoring subprocess 508 to readjust the audio levels. If the system determines that the adjustment of the setting was not successful, the system can return to step 504 to determine if there is a new audio source of interest by assessing whether the specific audio source the user is looking at meets the threshold to be identified as a potential source of interest.

After locking the system settings at step 512, the system can decide at step 514 whether to unlock the settings. If the system decides to unlock the current settings, the system goes back to the initial stage at 502. If the system decides to lock the current settings, the system keeps the current settings at 522.

FIG. 6 illustrates an example subprocess flow diagram of audio level monitoring in a selective audio system in accordance with some embodiments described herein. The audio level monitoring subprocess can adjust audio levels to desired thresholds and adjust the levels of background noise perceived by the user.

At 602, the system can use the input data to determine whether the audio levels are within threshold. The threshold levels can be adjusted by the user to their desired preference. If the user has not set minimum or maximum thresholds for audio source volume, a default value can be used. If the audio levels are not within threshold, the system can adjust the audio levels to meet the threshold 606. After adjusting the levels, the system can go back to 602 to reassess whether the audio levels are within threshold. If the audio levels are within threshold, the system proceeds to 604.

At 604, the system assesses whether there is too much background noise. The background noise level can be adjusted by the user to their desired preference. If the user has not set a threshold for background noise volume, a default value can be used. If background noise levels are too high, the system can reduce background noise 608. If background noise levels are not too high, the system proceeds out of the subprocess to 510 in FIG. 5.

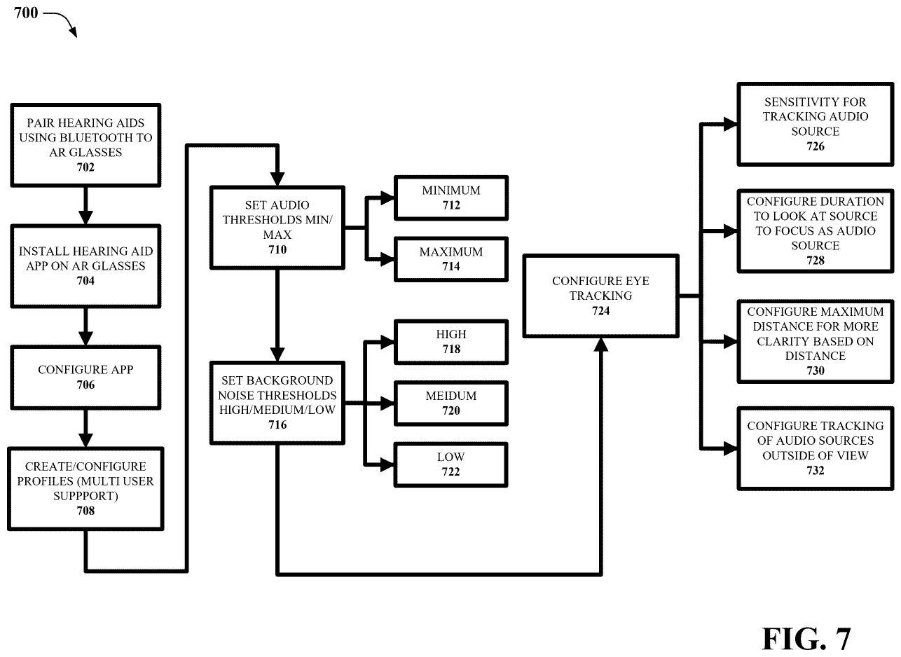

FIG. 7 illustrates an example process flow diagram of a user actions when using the augmented reality glasses paired with a hearing aid device in accordance with some embodiments described herein.

At 702, the user can pair a hearing aid device with the augmented reality glasses. The pairing of the devices can be achieved through Bluetooth or other suitable wireless communication methods.

Next, at 704 the user can install a hearing aid application on the augmented realty glasses that enables the selective audio system.

At 706, the user can configure the application. This can involve setting various preferences or security options to personalize the application's functionality.

At 708, the user can create or configure profiles on the application. This functionality can allow for multiuser support. User profiles can store information, such as volume preference levels.

The user can set their audio threshold preference at 710. Preferences can include their minimum volume preference levels 712 or their maximum volume preference levels 714. If the user has not set a minimum or maximum threshold for audio source volume, a default value can be used.

Next, the user can set background noise threshold 716 to control how much ambient sound they hear. Selecting low 722 minimizes background noise and can allow for a quieter experience with less distraction. Medium 420 can provide a balanced level of background sound and can allow the user to hear ambient noise while still focusing on the primary audio source. High 718 lets in more background noise, which can be helpful in environments where situational awareness is important. If the user has not set a threshold for background noise volume, a default value can be used.

At 724, the user can configure the eye tracking settings. This can include the sensitivity levels for tracking audio sources 726. Sensitivity levels can determine how responsive the system is to surrounding sounds. With high sensitivity, the system can detect and track a greater number of audio sources, including quieter sounds or sources at a farther distance. With low sensitivity, the system can focus only on louder or closer audio sources, filtering out background noise and minimizing distractions. In addition to adjusting sensitivity levels for audio tracking, the user can configure the duration to look at a source and focus the source as the audio source of interest 728. Additionally, the user can configure the maximum distance range for audio tracking 730, allowing the system to focus more clearly on sounds within a specified proximity. By setting a maximum distance range for audio tracking, the user can help conserve the device's battery, as the system expends less energy focusing only on sounds within the specified range. The user can additionally configure tracking of the audio sources outside of view 732. Since tracking audio sources outside of view requires more processing, limiting audio source tracking can help conserve battery life.

When the audio levels of the background and audio source are stabilized, the user can have the option to lock the current settings, so the volume levels remain constant. Locking can allow some of the microphones that aren't being actively used to turn off or enter a lower power state, saving overall battery life of the augmented reality glasses.

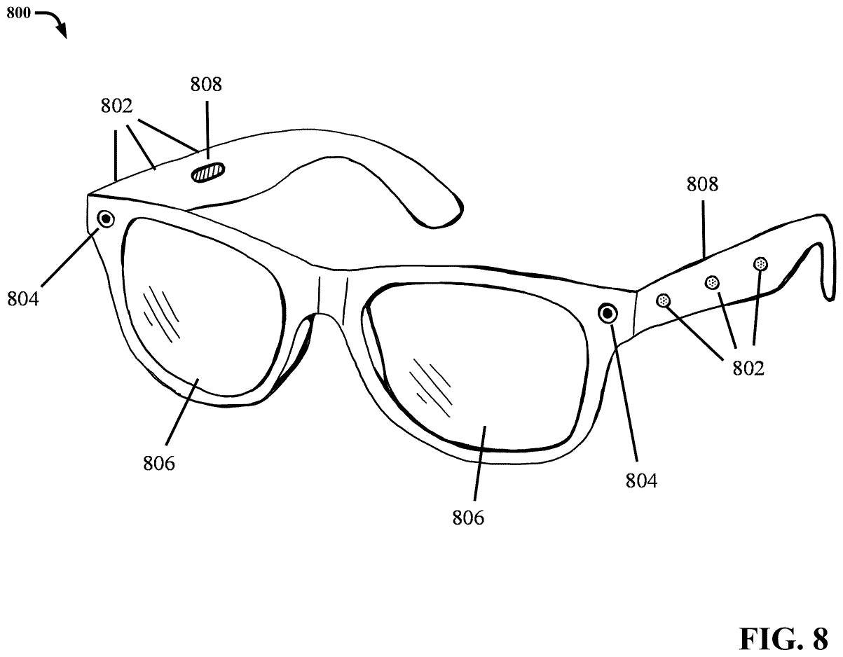

FIG. 8 illustrates an example structure for augmented reality glasses with a hearing aid device in accordance with some of the embodiments described herein. The embodiment shows an array of microphones located along both sides of the frame at 802. In other embodiments, microphones can be placed in other areas of the glasses. The use of multiple microphones built into augmented realty glasses can track the direction of a moving audio source. At 804, the augmented realty glasses can include one or multiple front-facing optical camera positioned along the bridge of the frame, providing a wide-angle field of view for capturing real-time environmental data. In other embodiments, the augmented realty glasses can include side cameras mounted near the outer edges of the lens area to enable additional functionalities, such as enhanced depth perception or gesture recognition.

In some embodiments, the augmented realty glasses can be equipped with an output sound feature positioned along the temples located at 808, designed to provide audio feedback or output to the user. This sound output feature can be integrated into the frame or can be paired with additional audio devices, such as hearing aids or headphones, to enhance user accessibility and audio quality without limiting the scope of the invention.

At 806, the augmented realty glasses can include interfaces embedded in the lens of the glasses. The interfaces can allow for direct user interaction and can display overlays that enhance the augmented reality experience, such as detected audio source of interest, audio levels, noise cancellation levels, or other settings or features related to the device. The interfaces can provide access to virtual content, facilitating user control, or enabling additional functionalities directly on the lens surface. The additional functionalities can be enabled using touch-based or gesture-based commands. The embodiments illustrated in FIG. 8 are exemplary and do not encompass every possible embodiment of the augmented reality glasses.

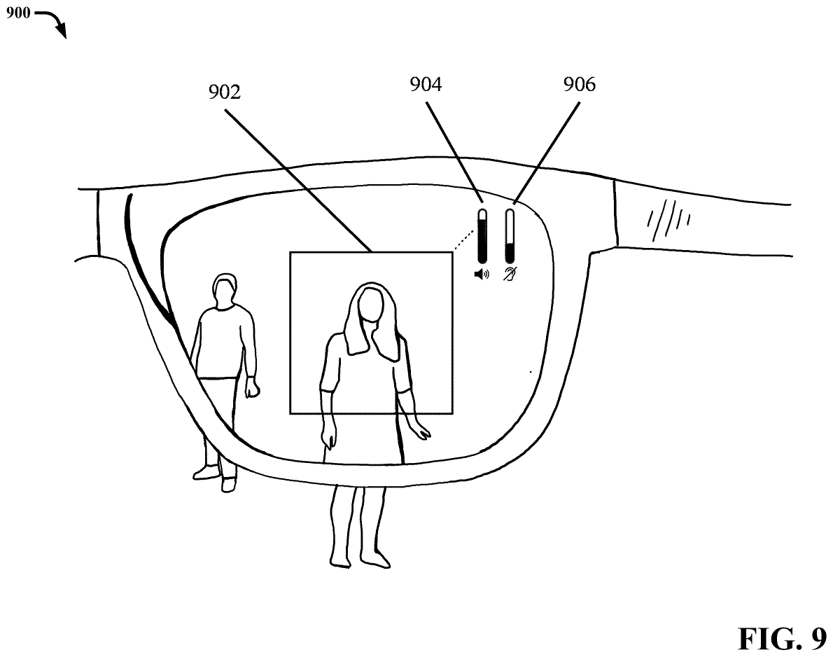

FIG. 9 illustrates an example interface for augmented reality glasses with a hearing aid device in accordance with some of the embodiments described herein. The figure shows an example user view of the interface. The interface shown in 900 can be embedded into the lens of the augmented reality glasses. At 902, the system can identify the audio source of interest. The interface can display the identified audio source visually by overlaying a box around the audio source. In other embodiments, the audio source may be represented differently or may not appear visually on the interface. The audio source of interest can be identified by eye movement tracking. The interface can display information regarding the audio source, including volume levels. Volume levels can be displayed as a sound bar 904. The user can adjust volume levels by interacting with the sound bar display through gesture controls, touch input on the frame, or voice commands. At 906, the interface can include a background noise cancellation bar allowing the user to control the level of ambient noise reduction. The level of background noise cancellation can be adjusted by the user by interacting with the augmented reality display. The embodiments illustrated in FIG. 9 are exemplary and do not encompass every possible embodiment of the interface.

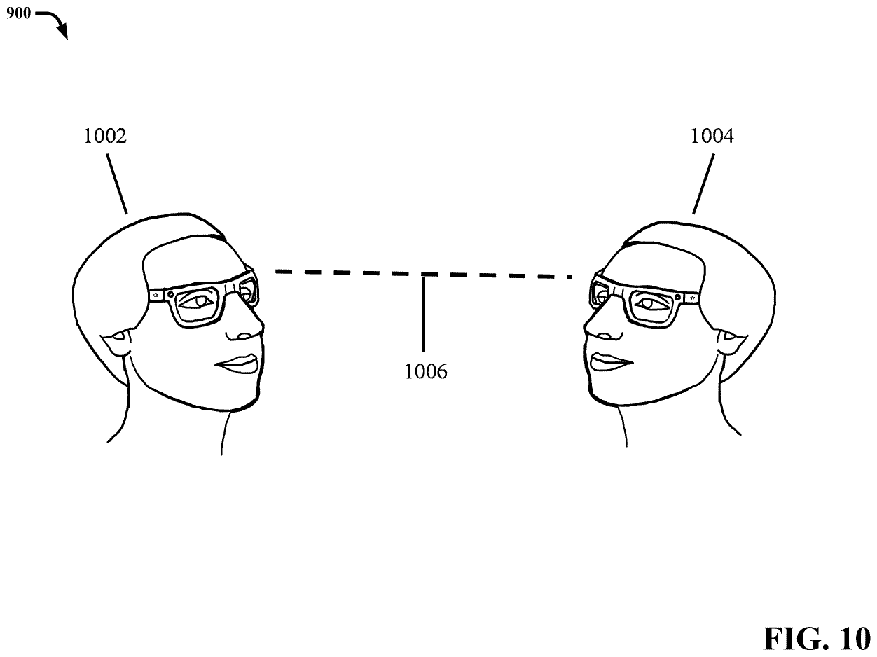

FIG. 10 illustrates an example private communication mode to enable secure and discrete interactions between multiple users in accordance with some of the embodiments described herein. In an embodiment, multiple users wearing the augmented reality glasses paired with a hearing aid device can engage in a private communication mode. The private mode can enable a direct communication channel between users isolated from surrounding audio.

Users can enter a private communication mode by interacting with the augmented reality glasses interface. Interactions can include gestures, voice commands, or touch sensitive controls located on the device. Once a user enters a private communication mode, the system can establish a communication link that allows users to share information exclusively with each other, such as audio, visual, or other data. The interface can include indicators or notifications to inform the users of the status of their private communication mode.

At 1002 and 1004, two users are displayed wearing augmented reality glasses paired with a hearing aid device. The two users, 1002 and 1004, are engaging in a private communication channel 1006. The two users are located at a distance away from each other but can communicate privately. The users can communicate effectively among each other in loud or crowded environments. The communication can be delivered through audio output into the hearing aid device or audio transmitter. In other embodiments, communication can be delivered visually by displaying as text displayed on the receiving user's interface. The private communication mode can allow users to engage in confidential interactions that could otherwise be disrupted by surrounding distractions.

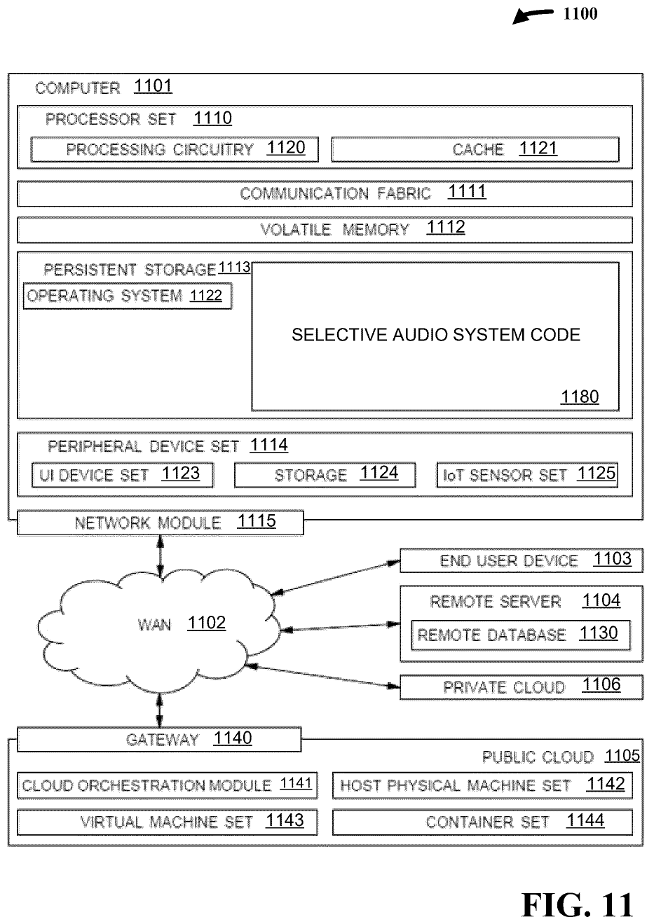

FIG. 11 and the following discussion are intended to provide a brief, general description of a suitable computing environment 1100 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as identifying a point of interest of a wearer of an augmented reality headset with selective audio code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1145 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer, and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an identification component that identifies a point of interest of a wearer of an augmented reality headset, wherein the augmented reality headset includes microphones and audio transmitter;
a focus component that isolates audio data received associated with the point of interest; and
an output component that amplifies isolated audio data output by the audio transmitter.

2. The system of claim 1, further comprising a language processing component that converts languages in real time to the wearer.

3. The system of claim 1, wherein the identification component uses eye movement tracking to identify the point of interest of the wearer.

4. The system of claim 1, wherein the identification component tracks movement of an audio source.

5. The system of claim 1, wherein output component adjusts settings in real time to improve audio quality.

6. The system of claim 1, wherein the focus component filters background noise.

7. The system of claim 1, wherein the output component is configured to adjust sound settings to optimize hearing for a selected sound source.

8. The system of claim 4, further comprising a storage component that saves stored volume thresholds for the audio source and background noise.

9. The system of claim 1, further comprising an artificial intelligence component that trains an artificial intelligence model on wearer preferences.

10. The system of claim 9, wherein the artificial intelligence component automatically adjusts hearing settings based on the wearer preferences.

11. A computer-implemented method that utilizes a processor that executes computer executable components stored in memory to perform the following acts:
identifying a point of interest of a wearer of an augmented reality headset, wherein the augmented reality headset includes microphones and audio transmitter;
isolating audio data received associated with the point of interest; and
amplifying isolated audio data output by the audio transmitter.

12. The method of claim 11, further comprising converting languages in real time to the wearer.

13. The method of claim 11, further comprising using eye movement tracking to identify the point of interest of the wearer.

14. The method of claim 11, further comprising tracking movement of an audio source.

15. The method of claim 11, further comprising adjusting settings in real time to improve audio quality.

16. The method of claim 11, further comprising filtering unwanted background noise from the point of interest.

17. The method of claim 11, further comprising adjusting sound settings to optimize hearing for selected sound source.

18. The method of claim 11, further comprising saving stored volume thresholds for audio source and background noise.

19. A computer program product comprising a computer readable storage medium having program instructions embodied therewith, the program instructions executable by a processor to cause the processor to:
identify a point of interest of a wearer of an augmented reality headset, wherein the augmented reality headset includes microphones and audio transmitter;
isolate audio data received associated with the point of interest; and
amplify isolated audio data output by the audio transmitter.

20. The computer program product of claim 19, the program instructions executable by a processor further cause the processor to:
use eye movement tracking to identify the point of interest of the wearer.
